(19) United States
(12) Patent Application Publication
(10) Pub. No.: US 2020/0304785 A1
(43) Pub. Date: Sep. 24, 2020

(54) SIMPLIFIED NON-LINEAR ADAPTIVE LOOP FILTER

(71) Applicant: QUALCOMM Incorporated, San Diego, CA (US)

(72) Inventors: Nan Hu, San Diego, CA (US); Vadim Seregin, San Diego, CA (US); Marta Karczewicz, San Diego, CA (US)

(21) Appl. No.: 16/818,338

(22) Filed: Mar. 13, 2020

Related U.S. Application Data
(60) Provisional application No. 62/822,653, filed on Mar. 22, 2019.

(51) Int. Cl. H04N 19/117; H04N 19/132; H04N 19/105; H04N 19/176; G06F 7/22

(52) U.S. Cl. CPC H04N 19/117; H04N 19/132; G06F 7/22; H04N 19/176; H04N 19/105

(57) ABSTRACT

This disclosure describes adaptive loop filtering (ALF). There is symmetry in the filter coefficients, and this symmetry may be leveraged so that the clipping function is performed on symmetrical input samples, rather than with respect to all samples used in the filter. In this way, the example techniques may reduce the number of operations performed by a video coder, thereby reducing the amount of time needed to perform the ALF process.

This application claims the benefit of U.S. Provisional Application 62/822,653, filed Mar. 22, 2019, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for utilizing a non-linear adaptive loop filter (NL-ALF). Based on symmetry of coefficients of the NL-ALF, a video coder (e.g., video encoder or video decoder) performing techniques as described in this disclosure may be configured to perform fewer computational operations as compared to other techniques for performing adaptive loop filtering (ALF). Accordingly, examples of the video coder described in this disclosure may perform adaptive loop filtering with less latency, resulting in improved video coding operation. For example, the example techniques described in this disclosure may be practical applications that improve the operation of a video coder and an associated video coding process, such as that of adaptive loop filtering, by improving computational efficiency of the video coder.

In one example, the disclosure describes a method of processing video data, the method comprising determining that adaptive loop filtering (ALF) is applied to a current sample of a block, determining a first set of input samples comprising input samples located along a first one or more directions relative to the current sample, determining a second set of input samples comprising input samples located along a second one or more directions relative to the current sample, wherein the second one or more directions are symmetrically opposite to the first one or more directions relative to the current sample, performing a clipping function based at least in part on the first set of input samples and the second set of input samples to generate respective clipped samples, and performing ALF on the current sample based at least in part on the respective clipped samples to generate a filtered sample.

In one example, the disclosure describes a device for processing video data, the device comprising a memory configured to store input samples and one or more processors comprising at least one of fixed-function or programmable circuitry. The one or more processors are configured to determine that adaptive loop filtering (ALF) is applied to a current sample of a block, determine a first set of input samples from the stored input samples comprising input samples located along a first one or more directions relative to the current sample, determine a second set of input samples from the stored input samples comprising input samples located along a second one or more directions relative to the current sample, wherein the second one or more directions are symmetrically opposite to the first one or more directions relative to the current sample, perform a clipping function based at least in part on the first set of input samples and the second set of input samples to generate respective clipped samples, and perform ALF on the current sample based at least in part on the respective clipped samples to generate a filtered sample.

In one example, the disclosure describes a device for processing video data, the device comprising means for determining that adaptive loop filtering (ALF) is applied to a current sample of a block, means for determining a first set of input samples comprising input samples located along a first one or more directions relative to the current sample, means for determining a second set of input samples comprising input samples located along a second one or more directions relative to the current sample, wherein the second one or more directions are symmetrically opposite to the first one or more directions relative to the current sample, means for performing a clipping function based at least in part on the first set of input samples and the second set of input samples to generate respective clipped samples, and means for performing ALF on the current sample based at least in part on the respective clipped samples to generate a filtered sample.

In one example, the disclosure describes a computer-readable storage medium having instructions stored thereon that when executed cause one or more processors to determine that adaptive loop filtering (ALF) is applied to a current sample of a block, determine a first set of input samples comprising input samples located along a first one or more directions relative to the current sample, determine a second set of input samples comprising input samples located along a second one or more directions relative to the current sample, wherein the second one or more directions are symmetrically opposite to the first one or more directions relative to the current sample, perform a clipping function based at least in part on the first set of input samples and the second set of input samples to generate respective clipped samples, and perform ALF on the current sample based at least in part on the respective clipped samples to generate a filtered sample.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIGS. 3A and 3B illustrate examples of filter coefficients for an adaptive loop filter (ALF).

FIGS. 4A and 4B are conceptual diagrams illustrating the symmetry of coefficients in FIGS. 3A and 3B, respectively.

FIGS. 5A and 5B are conceptual diagrams illustrating one-dimensional representations of coefficients in FIGS. 3A and 3B, respectively, that can be arranged as respective vectors.

FIGS. 6A and 6B are conceptual diagrams illustrating one-dimensional representations of coefficients in FIGS. 4A and 4B, respectively, that can be arranged as respective vectors.

FIGS. 7A and 7B are conceptual diagrams illustrating example locations of input samples for performing ALF in accordance with techniques described in this disclosure.

FIG. 8 is a block diagram illustrating an example video encoder that may perform the techniques of this disclosure.

FIG. 9 is a block diagram illustrating an example video decoder that may perform the techniques of this disclosure.

FIG. 10 shows an example implementation of a filter unit for performing the techniques of this disclosure.

FIG. 11 is a flowchart illustrating an example video encoding process.

FIG. 12 is a flowchart illustrating an example video decoding process.

FIG. 13 is a flowchart illustrating an example of processing video data in accordance with one or more examples described in this disclosure.

### DETAILED DESCRIPTION

This disclosure describes techniques related to filtering operations which could be used in a post-processing stage, as part of in-loop coding, or in the prediction stage of video coding. The techniques of this disclosure may be implemented into existing video codecs, such as HEVC (High Efficiency Video Coding), or be an efficient coding tool for a future video coding standard, such as VVC (Versatile Video Coding), also called the H.266 standard, presently under development.

Video coding typically involves predicting a block of video data from either an already coded block of video data in the same picture (i.e. intra prediction) or an already coded block of video data in a different picture (i.e. inter prediction). In some instances, the video encoder also calculates residual data by comparing a prediction block, generated from inter or intra-prediction, to the original block. Thus, the residual data represents a difference between the prediction block and the original block. The video encoder transforms and quantizes the residual data and signals the transformed and quantized residual data in the encoded bitstream. A video decoder adds the residual data to the prediction block to produce a reconstructed video block that matches the original video block more closely than the prediction block alone.

To further improve the quality of decoded video, a video decoder can perform one or more filtering operations on the reconstructed video blocks. Examples of these filtering operations include deblocking filtering, sample adaptive offset (SAO) filtering, and adaptive loop filtering (ALF). Parameters for these filtering operations may either be determined by a video encoder and explicitly signaled in the encoded video bitstream or may be implicitly determined by a video decoder without needing the parameters to be explicitly signaled in the encoded video bitstream.

This disclosure describes techniques related to ALF, including non-linear ALF (NL-ALF). ALF may be used in a post-processing stage or for in-loop coding, or in a prediction process. For example, the video decoder may perform the example adaptive loop filtering techniques to generate a block that is outputted for display. The video encoder includes a reconstruction (e.g., decoding loop), and the video encoder may be configured to perform the example adaptive loop filtering techniques as part of the decoding loop.

As used in this disclosure, the term video coding generically refers to either video encoding or video decoding. Similarly, the term video coder may generically refer to a video encoder or a video decoder. Moreover, certain techniques described in this disclosure with respect to video decoding may also apply to video encoding, and vice versa. For example, often times video encoders and video decoders are configured to perform the same process, or reciprocal processes. Also, a video encoder typically performs video decoding as part of the processes of determining how to encode video data.

In some examples, the video coder performs ALF on a sample-by-sample basis. For example, for a current sample of a block, the video coder may scale input samples of the ALF process with filter coefficients and sum the scaled input samples to generate a filtered output sample for the current sample of the block. The input samples may be neighboring and proximate samples to the current sample of the block.

To make the ALF process more efficient, the video coder may utilize a clipping function. The use of the clipping function tends to add non-linearity to the ALF process (i.e., non-linear ALF or NL-ALF), but the efficiency gained with the clipping function may outweigh any minimal negative impact of the non-linearity in the filtering (e.g., the amount of blurring applied to samples may not be linear with the color values of the samples). Hence, in NL-ALF, the video coder performs subtraction as part of the clipping function, the clipping operation as part of the clipping function, multiplication (e.g., scaling of respective values generated from the clipping function), and addition of the respective scaled values generated from the clipping function.

This disclosure describes examples to further improve the ALF process by potentially reducing the amount of subtraction and clipping operations that need to be performed as part of the clipping function. For instance, as described in more detail below, there is symmetry in the filter coefficients, and this symmetry may be leveraged so that the clipping function is performed on symmetrical input samples, rather than with respect to all samples used in the filter. In this way, the example techniques may reduce the number of operations performed by the video coder, thereby reducing the amount of time needed to perform the ALF process.

Symmetry or symmetrical, as used in this disclosure, refers to symmetry relative to the current sample for which the ALF process is being performed. For instance, a first input sample may be N number of samples to the left of the current sample for which the ALF process is being performed. A second input sample that is symmetrical to the first input sample may be N number of samples to the right of the current sample for which the ALF process is being performed. Similarly, a first input sample may be N number of samples above the current sample for which the ALF process is being performed, and a second input sample that is symmetrical to the first input sample may be N number of samples below the current sample for which the ALF process is being performed. As another example, a first input sample may be N number of samples above the current sample and M number of samples to the left of the current sample, and a second input sample that is symmetrical to the first input sample may be N number of samples below the current sample and M number of samples to the right of the current sample.

Accordingly, in one or more examples, a first set of input samples may be input samples located along a first one or more directions (e.g., a first horizontal direction, a first vertical direction, or a first diagonal direction) relative to the current sample, and a second set of input samples may be input samples located along a second one or more directions (e.g., a second horizontal direction, a second vertical direction, or a second diagonal direction) relative to the current sample. The second one or more directions may be symmetrically opposite to the first one or more directions relative to the current sample. For example, if the first horizontal direction is left of current sample, then the second horizontal direction is right of the current sample, or vice-versa. If the first vertical direction is above the current sample, then the second vertical direction is below the current sample, or vice-versa.

Mathematically, symmetrical samples may be represented as I(i,j) and I(−i,−j), relative to a current sample that is located at I(0,0), where I(i,j) is a first input sample and I(−i,−j) is a second input sample that is symmetrical to the first input sample. As described in more detail below, the input samples may be represented in a one-dimensional (1-D) domain. In such examples, I(i) represents a first input sample, I(c) represents the current sample, and I(i′) represents a second input sample that is symmetrical with the first input sample relative to the current sample. For example, if I(i) represents a first input sample that is two above and one to the right of the current sample, then I(i′) represents a second input sample that is two below and one to the left of the current sample.

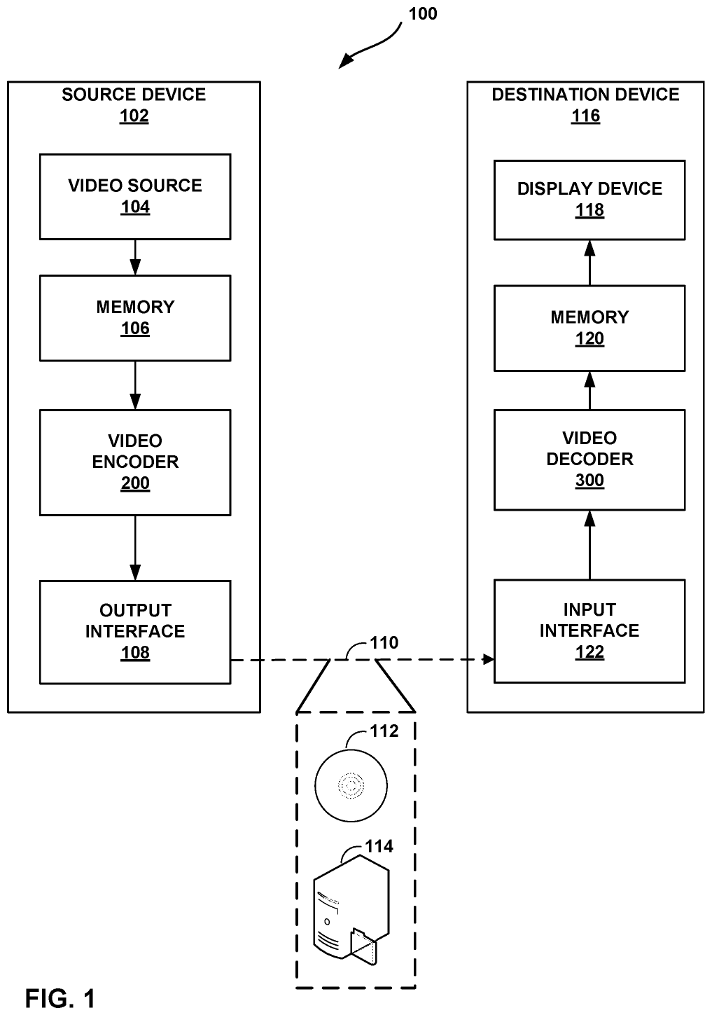

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for adaptive loop filtering including non-linear adaptive loop filtering. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for adaptive loop filtering. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM) or ITU-T H.266, also referred to as Versatile Video Coding (VVC). A draft of the VVC standard is described in Bross, et al. “Versatile Video Coding (Draft 4),” Joint Video Experts Team (JVET) of ITU-T SG 16 WP 3 and ISO/IEC JTC 1/SC 29/WG 11, 13^{th} Meeting: Marrakech, Mass., 9-18 Jan. 2019, JVET-M1001-v5 (hereinafter “VVC Draft 4”). A more recent draft of the VVC standard is described in Bross, et al. “Versatile Video Coding (Draft 7),” Joint Video Experts Team (JVET) of ITU-T SG 16 WP 3 and ISO/IEC JTC 1/SC 29/WG 11, 16^{th} Meeting: Geneva, CH, 1-11 Oct. 2019, JVET-P2001-v14 (hereinafter “VVC Draft 7”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as including coding values for syntax elements associated with the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM or VVC. According to JEM or VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of JEM and VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning of a picture into CTUs and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As described in more detail, video encoder 200 and/or video decoder 300 may perform adaptive loop filtering (e.g., the ALF process) on samples resulting from the reconstruction of a current block. For example, video encoder 200 includes a reconstruction process, and the ALF process may be applied to the result of the reconstruction process (e.g., ALF may be performed subsequent to a reconstruction process). Video decoder 300 may perform the ALF process prior to the display of the reconstructed block (e.g., the ALF process may be performed subsequent to a decoding process on the block).

The ALF process may involve input samples that are neighboring or proximate to the current sample for which the ALF process is being performed. In one or more examples, the input samples may be symmetrical input samples. For instance, video encoder 200 and video decoder 300 may determine a first set of input samples including input samples located along a first one or more directions relative to the current sample (e.g., horizontally, vertically, or diagonally in a first direction). Video encoder 200 and video decoder 300 may determine a second set of input samples including input samples located along a second one or more directions relative to the current sample (e.g., horizontally, vertically, or diagonally in a second direction). The second one or more directions may be symmetrically opposite to the first one or more directions relative to the current sample (e.g., the first direction is opposite to the second direction).

As an example, if the current sample is located at (0,0), then a first input sample may be located at (−3, 0) and a second input sample, that is symmetrical with the first input sample, may be located at (3, 0). In this example, the first input sample is located in a first horizontal direction (e.g., left), and the second input sample is located in a second horizontal direction (e.g., right), which is symmetrically opposite to the first horizontal direction. As another example, a first input sample may be located at (−1, 2) and a second input sample, that is symmetrical with the first input sample, may be located at (1, −2). In this example, the first input sample is located in a first diagonal direction (e.g., one to the left, and two above), and the second input sample is located in a second diagonal direction (e.g., one to the right and two below), which is symmetrically opposite to the first diagonal direction. That is, if a first input sample is located at (i,j) and is in a first direction relative to the current sample, then a second input sample that is symmetrical to the first input sample relative to the current sample is located at (−i,−j) and is in a second direction relative to the current sample that is symmetrically opposite to the first direction.

As described in more detail, video encoder 200 and video decoder 300 may perform a clipping function based at least in part on the first set of input samples and the second set of input samples to generate respective clipped samples. Video encoder 200 and video decoder may perform ALF on the current sample based at least in part on the respective clipped samples to generate a filtered sample.

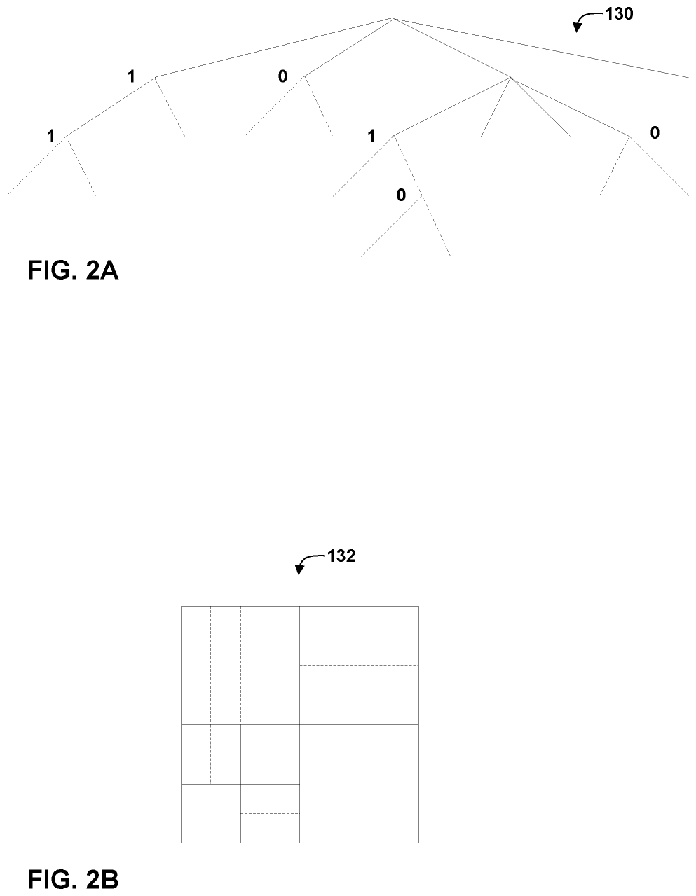

FIGS. 2A and 2B are conceptual diagram illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

As described, video encoder 200 and video decoder 300 may be configured to implement various ALF filtering techniques. Aspects of these filtering techniques (e.g., ALF) will now be described. VVC also includes another filter, called Geometry transformation-based Adaptive Loop Filtering (GALF). The input to ALF/GALF may be the reconstructed image after the application of SAO (e.g., output of sample adaptive offset). Aspects of GALF are described in Tsai, C. Y., Chen, C. Y., Yamakage, T., Chong, I. S., Huang, Y. W., Fu, C. M., Itoh, T., Watanabe, T., Chujoh, T., Karczewicz, M. and Lei, S. M., “Adaptive loop filtering for video coding,” IEEE Journal of Selected Topics in Signal Processing, 7(6), pp. 934-945, 2013 and in M. Karczewicz, L. Zhang, W.-J. Chien, and X. Li, “Geometry transformation-based adaptive in-loop filter”, Picture Coding Symposium (PCS), 2016.

ALF techniques attempt to minimize the mean square error between original samples and decoded samples by using an adaptive Wiener filter (as one non-limiting example). Denote the input image asp, the source image as S, and the FIR filter as h. Then the following expression of the sum of squared errors (SSE) may be found to be less than a threshold (e.g., minimized), where (x,y) denotes any pixel position in p or S.

SSE=Σ_{x,y}(Σ_{i,j}h(i,j)p(x−i,y−j)−S(x,y))²

The optimal h, denoted as hₒₚₜ, can be obtained by setting the partial derivative of SSE with respect to h(i,j) equal to 0 as follows:

$$\frac{\partial S S E}{\partial h ( i , j )} = 0$$

This leads to the Wiener-Hopf equation shown below, which gives the optimal filter hₒₚₜ:

hₒₚₜ(i,j)(Σ_{x,y}p(x−i,y−j)p(x−m,y−n))=Σ_{x,y}S(x,y)p(x−m,y−n)

In some examples, instead of using one filter for the whole picture, samples in a picture are classified into twenty-five (25) classes, based on the local gradients. Separate optimal Wiener filters are derived for the pixels in each class. Several techniques have been employed to increase the effectiveness of ALF by reducing signaling overhead and computational complexity. Some of the techniques to increase ALF effectiveness by reducing signaling overhead and/or computational complexity are listed below:
1. Prediction from fixed filters: Optimal filter coefficients for each class are predicted using a prediction pool of fixed filters which consists of 16 candidate filters for each class. The best prediction candidate is selected for each class and only the prediction errors are transmitted.
2. Class merging: Instead of using twenty five (25) different filters (one for each class), pixels in multiple classes can share one filter in order to reduce the number of filter parameters to be coded. Merging two classes can lead to higher cumulative SSE but lower RD cost.
3. Variable number of taps: The number of filter taps is adaptive at the frame level. Theoretically, filters with more taps can achieve lower SSE, but may not be a good choice in terms of Rate-Distortion (R-D) cost, because of the bit overhead associated with more filter coefficients.
4. Block level on/off control: ALF can be turned on and off on a block basis. The block size at which the on/off control flag is signaled is adaptively selected at the frame level. Filter coefficients may be recomputed using pixels from only those blocks for which is ALF is on.
5. Temporal prediction: Filters derived for previously coded frames are stored in a buffer. If the current frame is a P or B frame, then one of the stored set of filters may be used to filter this frame if it leads to better RD cost. A flag is signaled to indicate usage of temporal prediction. If temporal prediction is used, then an index indicating which set of stored filters is used is signaled. No additional signaling of ALF coefficients is needed. Block level ALF on/off control flags may be also signaled for a frame using temporal prediction.

Details of some aspects of ALF are summarized briefly. The description of ALF is provided merely to assist with understanding and the techniques described in this disclosure should not be considered limited to the following aspects of ALF.

Some aspects of ALF are related to pixel classification and geometry transformation. Sums of absolute values of vertical, horizontal and diagonal Laplacians at all pixels within a 6×6 window that covers each pixel in a reconstructed frame (before ALF) are computed. The reconstructed frame is then divided into non-overlapped 2×2 blocks. The four pixels in these blocks are classified into one of twenty five (25) categories, denoted as Cₖ (k=0, 1, . . . , 24), based on the total Laplacian activity and directionality of that block. Additionally, one of four geometry transformations (no transformation, diagonal flip, vertical flip or rotation) is also applied to the filters based on the gradient directionality of that block. The details can be found in M. Karczewicz, L. Zhang, W.-J. Chien, and X. Li, “Geometry transformation-based adaptive in-loop filter,” Picture Coding Symposium (PCS), 2016.

Some aspects of ALF are related to filter derivation and prediction from fixed filters. For each class Cₖ, a best prediction filter is first selected from the pool for Cₖ, denoted as h_{pred,k}, based on the SSE given by the filters. The SSE of Cₖ, which is to be minimized, can be written as below,

SSEₖ=Σ_{x,y}(Σᵢⱼ(h_{pred,k}(i,j)+h_{Δ,k}(i,j))p(x−i,y−j)−S(x,y))²,k=0, . . . ,24,(x,y)∈Cₖ,

where k_{Δ,k} is the difference between the optimal filter for Cₖ and h_{pred,k}. Let p′(x,y)=Σ_{i,j}h_{pred,k}(i,j)p(x−i,y−j) be the result of filtering pixel p(x, y) by h_{pred,k}. Then the expression for SSEₖ can be re-written as

$$S S {E}_{k} = {\sum }_{x , y} {( {\sum }_{i , j} {h}_{Δ , k} ( i , j ) p ( x - i , y - j ) - ( S ( x , y ) - {p}^{′} ( x , y ) ) )}^{2}$$

$$k = 0 , … , 24 , ( x , y ) ∈ {C}_{k}$$

By making the partial derivative of SSEₖ with respect to h_{Δ,k}(i,j) equal to 0, the modified Wiener-Hopf equation is obtained as follows:

$${\sum }_{i , j} {h}_{Δ , k} ( i , j ) ( {\sum }_{x , y} p ( x - i , y - j ) p ( x - m , y - n ) ) = {\sum }_{x , y} ( S ( x , y ) - {p}^{′} ( x , y ) ) p ( x - m , y - n )$$

$$k = 0 , … , 24 , ( x , y ) ∈ {C}_{k}$$

For the simplicity of expression, denote Σ_{x,y}p(x−i,y−j)p(x−m,y−n) and Σ_{x,y}(S(x,y)−p′ (x,y))p(x−m,y−n) with (x,y)∈Cₖ by R_{pp,k}(i−m, j−n) and R′_{ps,k}(m,n), respectively. Then, the above equation can be written as:

Σ_{i,j}h_{Δ,k}(i,j)R_{pp,k}(i−m,j−n)=R′_{ps,k}(m,n)k=0, . . . ,24

For every Cₖ, the auto-correlation matrix R_{pp,k}(i−m,j−n) and cross-correlation vector R′_{ps,k}(m, n) are computed over all (x,y)∈Cₖ.

In one example of ALF, only the difference between the optimal filter and the fixed prediction filter is calculated and transmitted. If none of the candidate filters available in the pool is a good predictor, then the identity filter (i.e., the filter with only one non-zero coefficient equal to 1 at the center that makes the input and output identical) will be used as the predictor.

Some aspects of ALF relate to the merging of pixel classes. Classes are merged to reduce the overhead of signaling filter coefficients. The cost of merging two classes is increased with respect to SSE. Consider two classes Cₘ and Cₙ with SSEs given by SSEₘ and SSEₙ, respectively. Let Cₘ₊ₙ denote the class obtained by merging Cₘ and Cₙ with SSE, denoted as SSEₘ₊ₙ. SSEₘ₊ₙ is always greater than or equal to SSEₘ+SSEₙ. Let ΔSSEₘ₊ₙ denote the increase in SSE caused by merging Cₘ and Cₙ, which is equal to SSEₘ₊ₙ−(SSEₘ+SSEₙ). To calculate SSEₘ₊ₙ, one needs to derive h_{Δ,m+n}, the filter prediction error for Cₘ₊ₙ, using the following expression similar to above examples.

Σ_{i,j}h_{Δ,m+n}(i,j)(R_{pp,m}(i−u,j−v)+R_{pp,n}(−u,j−v))=R′_{ps,m}(u,v)+R′_{ps,n}(u,v)

The SSE for the merged category Cₘ₊ₙ can then be calculated as:

SSEₘ₊ₙ=−Σ_{u,v}h_{Δ,m+n}(u,v)(R′_{ps,m}(u,v)+R′_{ps,n}(u,v))+(R_{ss,m}+R_{ss,n})

To reduce the number of classes from N to N−1, two classes Cₘ and Cₙ may need to be found, such that merging them leads to the smallest ΔSSEₘ₊ₙ compared to any other combinations. Some ALF designs check every pair of available classes for merging to find the pair with the smallest merge cost.

If Cₘ and Cₙ (with m<n) are merged, then Cₙ is marked unavailable for further merging and the auto- and cross-correlations for Cₘ are changed to the combined auto- and cross-correlations as follows:

R_{pp,m}=R_{pp,m}+R_{pp,n}

R′_{ps,m}=R′_{ps,m}+R′_{ps,n}

R_{ss,m}=R_{ss,m}+R_{ss,n}.

An optimal number of ALF classes after merging needs to be decided for each frame based on the RD cost. This is done by starting with twenty-five (25) classes and merging a pair of classes (from the set of available classes) successively until there is only one class left. For each possible number of classes (1, 2, . . . , 25) left after merging, a map indicating which classes are merged together is stored. The optimal number of classes is then selected such that the RD cost is minimized as follows:

$${N}_{o p t} = {arg min}_{N} ( J {\vert}_{N} = D {\vert}_{N} + λ R {\vert}_{N} ) ,$$

where D|_{N} is the total SSE of using N classes (D|_{N}=Σₖ₌₀^{N-1}SSEₖ), R|_{N} is the total number of bits used to code the N filters, and λ is the weighting factor determined by the quantization parameter (QP). The merge map for Nₒₚₜ number of classes, indicating which classes are merged together, is transmitted.

Aspects of the signaling of ALF parameters are now described. A brief step-by-step description of the ALF parameter encoding process is given below:
1. Signal the frame level ALF on/off flag.
2. If ALF is on, then signal the temporal prediction flag.
3. If temporal prediction is used, then signal the index of the frame from which the corresponding ALF parameters are used for filtering the current frame.
4. If temporal prediction is not used, then signal the auxiliary ALF information and filter coefficients as follows:
   a. Following auxiliary ALF information is signaled before signaling the filter coefficients.
      i. The number of unique filters used after class merging.
      ii. Number of filter taps.
      iii. Class merge information indicating which classes share the filter prediction errors.
      iv. Index of the fixed filter predictor for each class.
   b. After signaling the auxiliary information, filter coefficient prediction errors are signaled as follows:
      i. A flag is signaled to indicate if the filter prediction errors are forced to zero (0) for some of the remaining classes after merging.
      ii. A flag is signaled to indicate if differential coding is used for signaling filter prediction errors (if the number of classes left after merging is larger than one (1)).
      iii. Filter coefficient prediction errors are then signaled using k-th order Exp-Golomb code, where the k-value for different coefficient positions is selected empirically.
   c. Filter coefficients for chroma components, if available, are directly coded without any prediction methods.
5. Finally, the block-level ALF on/off control flags are signaled.

The following describes some additional examples of adaptive loop filtering (ALF filtering). In Versatile Video Coding Test Model (VTM) 4.0, the ALF filtering can be expressed as follows: O(x,y)=Σ_{(i,j)}w(i,j).I(x+i,y+j) (equation 1), where samples I(x+i,y+j) are input samples, O(x,y) is the filtered output sample (i.e., filter result), and w(i,j) denotes the filter coefficients. Equation 1 is one example way of performing the ALF operations.

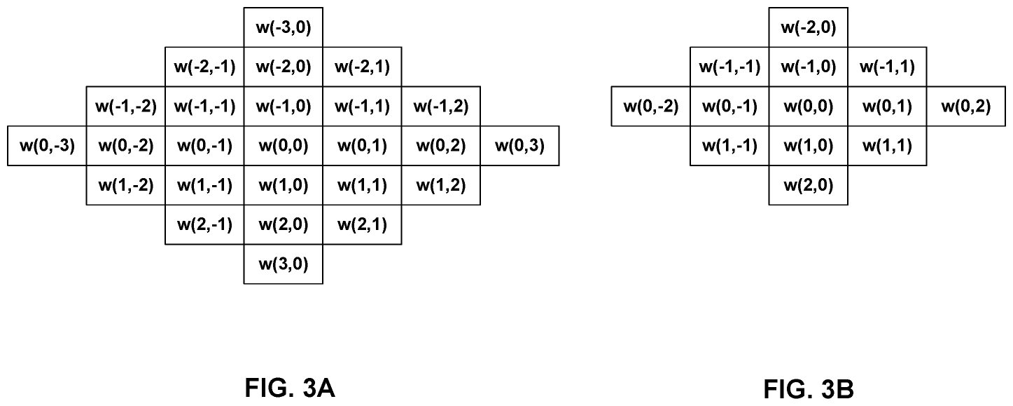

FIGS. 3A and 3B illustrate examples of filter coefficients for ALF. For example, FIG. 3A illustrates example filter coefficients w(i,j) for 7×7 ALFs in VTM 4.0. For instance, if a 7×7 ALF filter is used on a current sample, the example of the filter coefficients is shown in FIG. 3A. FIG. 3B illustrates example filter coefficients w(i,j) for 5×5 ALFs in VTM 4.0. For instance, if a 5×5 ALF filter is used on a current sample, the example of the filter coefficients is shown in FIG. 3B.

In practice, in VTM 4.0, ALF is implemented by video encoder 200 and video decoder 300 using integer arithmetic for fixed point precision computations as follows:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) ≫ 7 , \qquad ( equation 2 )$$

In equation 2, L denotes the filter length, and w(i,j) are the filter coefficients in fixed point precision.

Equation 1 can be reformulated, without coding efficiency impact, in the following expression: O(x,y)=I(x,y)+Σ_{(i,j)≠(0,0)}w(i,j).(I(x+i,y+j)−I(x,y)), (Equation 3), where w(i,j) are the same filter coefficients as in equation 1 [except w(0, 0) which is equal to 1 in equation 3 while it is equal to 1−Σ_{(i,j)≠(0,0)}w(i,j) in equation 1].

Using this above filter formula of equation 3, nonlinearity can be introduced to make ALF more efficient by using a simple clipping function to reduce the impact of neighbor sample values (I(x+i, y+j)) such as when neighbor sample values are too different relative to the current sample value (I(x,y)) being filtered.

In Taquet, et al. “Non-Linear Adaptive Loop Filter,” Joint Video Experts Team (JVET) of ITU-T SG 16 WP 3 and ISO/IEC JTC 1/SC 29/WG 11, 13^{th} Meeting: Marrakech, Mass., 9-18 Jan. 2019, JVET-M0385 (hereinafter “JVET-M0385”), the ALF filter is modified as follows: O′(x,y)=I(x,y)+Σ_{(i,j)≠(0,0)}w(i,j). K(I(x+i,y+j)−I(x,y),k(i,j)) (equation 4), where K(d,b)=min (b,max(−b,d)) is the clipping function, and k(i,j) are clipping parameters, which depend on the (i,j) filter coefficient. In some examples, video encoder 200 may perform the optimization (e.g., based on Rate-Distortion (R-D) cost) to find the best k(i,j) and signal the values of k(i,j) to video decoder 300.

There may be technical problems with the use of the NL-ALF in JVET-M0385. For example, due to the relatively large number of computations required by video encoder 200 and video decoder 300 to perform the NL-ALF operations, video encoder 200 and video decoder 300 may be delayed in completing the NL-ALF operations, resulting in increased video coding latency. As one example, using JVET-M0385 NL-ALF, the total number of operations per filtered Luma sample can be: 12 multiplications, 13 additions, 24 subtractions, and 24 clippings. The total number of operations per filtered Chroma sample can be 6 multiplications, 7 additions, 12 subtractions, and 12 clippings.

In accordance with the techniques described in this disclosure, video encoder 200 and video decoder 300 may perform fewer operations for ALF filtering, as compared to the techniques of JVET-M0385. For example, considering the symmetry of coefficients of ALF in VTM, i.e., w(i,j)=w(−i,−j) for some of the coefficients, the number of clipping operations in equation (4) could be reduced by half. Accordingly, in some examples, video encoder 200 and video decoder 300 may be configured to perform half of the clipping operations that would have been needed in the JVET-M0385 ALF techniques, resulting in faster video coding processes, particularly with respect to ALF.

The example filter coefficients in FIGS. 3A and 3B can be mapped to respective input samples. For instance, if a 7×7 ALF filter of FIG. 3A is used, then filter coefficient w(0,0) is for the current sample, filter coefficient w(0,−1) is for an input sample that is one to the left of the current sample, filter coefficient w(0,1) is for an input sample that is one to the right of the current sample, filter coefficient w(−1,−1) is for an input sample that is one above and one to the right of the current sample, filter coefficient w(1,1) is for an input sample that is one below and one to the left of the current sample, and so forth. The same mapping of filter coefficient to input samples is applicable to the 5×5 ALF filter of FIG. 3B.

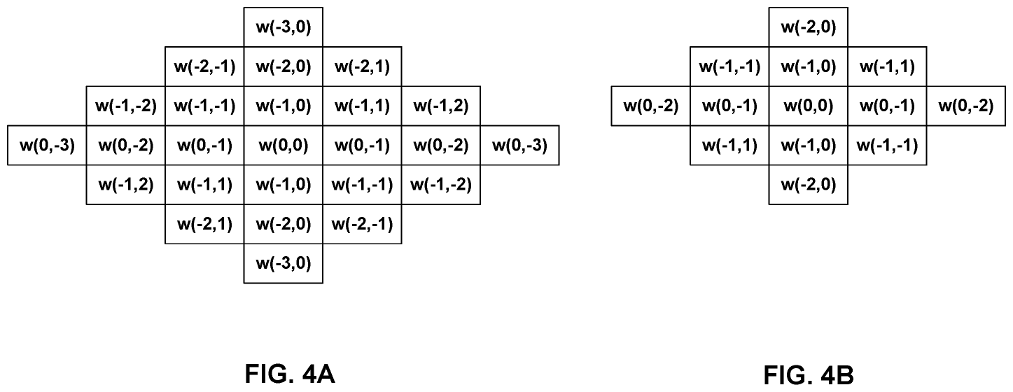

FIGS. 4A and 4B are conceptual diagrams illustrating the symmetry of coefficients in FIGS. 3A and 3B, respectively. FIG. 4A illustrates example filter coefficients w(i,j) for 7×7 ALFs in VTM 4.0 and the symmetry of the filter coefficients for 7×7 ALFs. FIG. 4B illustrates example filter coefficients w(i,j) for 5×5 ALFs in VTM 4.0 and the symmetry of the filter coefficients for 5×5 ALFs.

As one example, in FIG. 3A, there is a filter coefficient w(0, −3) and w(0, 3). However, filter coefficient w(0, −3) and w(0, 3) may be the same. In some examples, filter coefficient w(0, −3) and w(0, 3) may be different and other filter coefficients may the same. In FIG. 4A, the filter coefficient w(0, 3) of FIG. 3A is replaced by filter coefficient w(0, −3). As one example, in FIG. 3B, there is a filter coefficient w(0, −2) and w(0, 2). However, filter coefficient w(0, −2) and w(0, 2) may be the same. In some examples, filter coefficient w(0, −2) and w(0, 2) may be different and other filter coefficients may the same. In FIG. 4B, the filter coefficient w(0, 2) of FIG. 3B is replaced by filter coefficient w(0, −2).

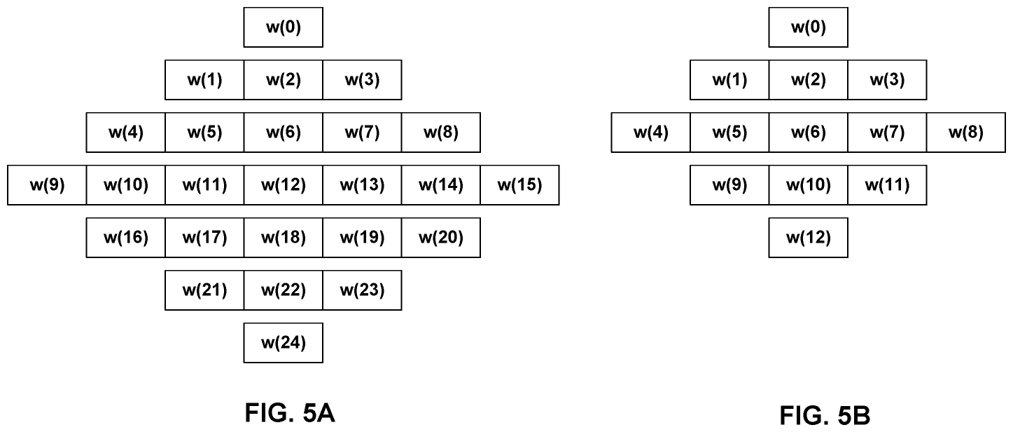

FIGS. 5A and 5B are conceptual diagrams illustrating one-dimensional representations of coefficients in FIGS. 3A and 3B, respectively, that can be arranged as respective vectors. The filter coefficients and pixels can be re-organized as vectors (e.g., one-dimensional vectors). For example, in FIG. 5A, the filter coefficients are organized as w(0) to w(24) and can be organized as a one-dimensional vector. Filter coefficient w(12) in FIG. 5A is for the current sample. In FIG. 5B, the filter coefficients are organized as w(0) to w(12) and can be organized as a one-dimensional vector. Filter coefficient w(6) in FIG. 5B is for the current sample.

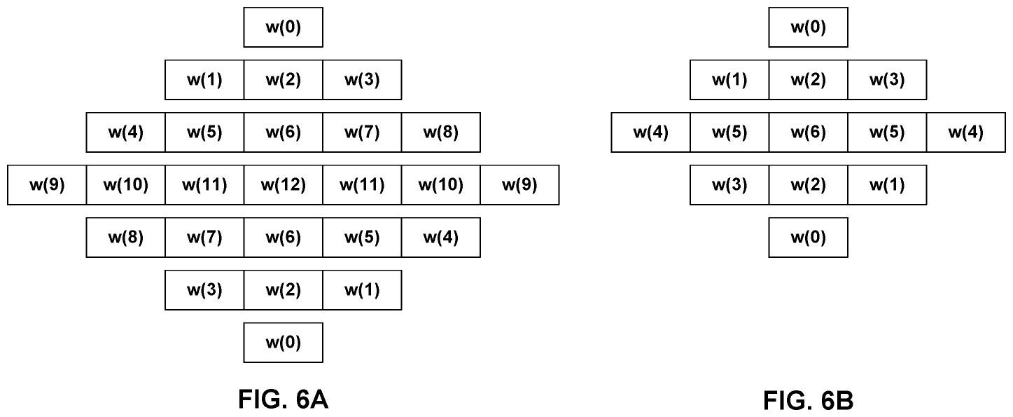

FIGS. 6A and 6B are conceptual diagrams illustrating one-dimensional representations of coefficients in FIGS. 4A and 4B, respectively, that can be arranged as respective vectors. The filter coefficients and pixels can be re-organized as vectors (e.g., one-dimensional vectors). For example, in FIG. 6A, the filter coefficients of FIG. 5A are organized as w(0) to w(12) due to the symmetry and can be organized as a one-dimensional vector. In FIG. 6B, the filter coefficients of FIG. 5B are organized as w(0) to w(6) due to the symmetry and can be organized as a one-dimensional vector.

According to FIGS. 5A and 5B, equation 1 could be rewritten in 1-D domain as O=I(c)+Σ_{i≠c}w(i).(I(i)−I(c)) (equation 5), where c is the index of the central pixel (e.g., current sample), which will be 12 for the 7×7 filter in FIGS. 5A and 6 for the 5×5 filter in FIG. 5B. In equation 5, i is the index of pixel (e.g., input sample), which could be from 0 to 24 for a 7×7 filter and 0 to 12 for a 5×5 filter.

Equation 3 could be rewritten in 1-D domain as O=I(c)+Σ_{i≠c}w(i)*(I(i)−I(c)) (equation 6), and equation 4 could be rewritten in 1-D domain as O′=I(c)+Σ_{i≠c}w(i)*K(I(i)−I(c),k(i)) (equation 7).

Based on the symmetry in FIGS. 6A and 6B, equation 7 could be rewritten as O′=I(c)+Σ_{i=0 . . . 5 or 0 . . . 11}w(i)*[K(I(i)−I(c),k(i))+K(I(i′)−I(c),k(i′))] (equation 8), where i=0 . . . 5 for 5×5 filter and i=0 . . . 11 for a 7×7 filter and i′ is the coordinate of the symmetrized location of i. The symmetrized location of i (i.e., i′) is equal to a location that is the same number of samples away from the current sample as location i, but in the symmetrically opposite direction as the current sample. For example, if I(i) is located two samples to the left of the current sample, then I(i′) is located two samples to the right of the current sample.

Since k(i)=k(i′), equation 8 can be rewritten as O′=I(c)+Σ_{i=0 . . . 5 or 0 . . . 11}w(i)*[K(I(i)+I(i′)−2*I(c),k(i))] (equation 9).

In this way, the number of clipping and subtraction operations in equation 4 may be reduced by half but reducing the operations by exactly half is not necessary in all examples. In other words, video encoder 200 and video decoder 300 may be configured to perform the operations of equation 9 to perform the ALF filtering, and performing the operation of equation 9 may result in video encoder 200 and video decoder 300 performing fewer operations (e.g., clipping and subtraction operations) as compared the operations that video encoder 200 and video decoder 300 would perform for equation 7.

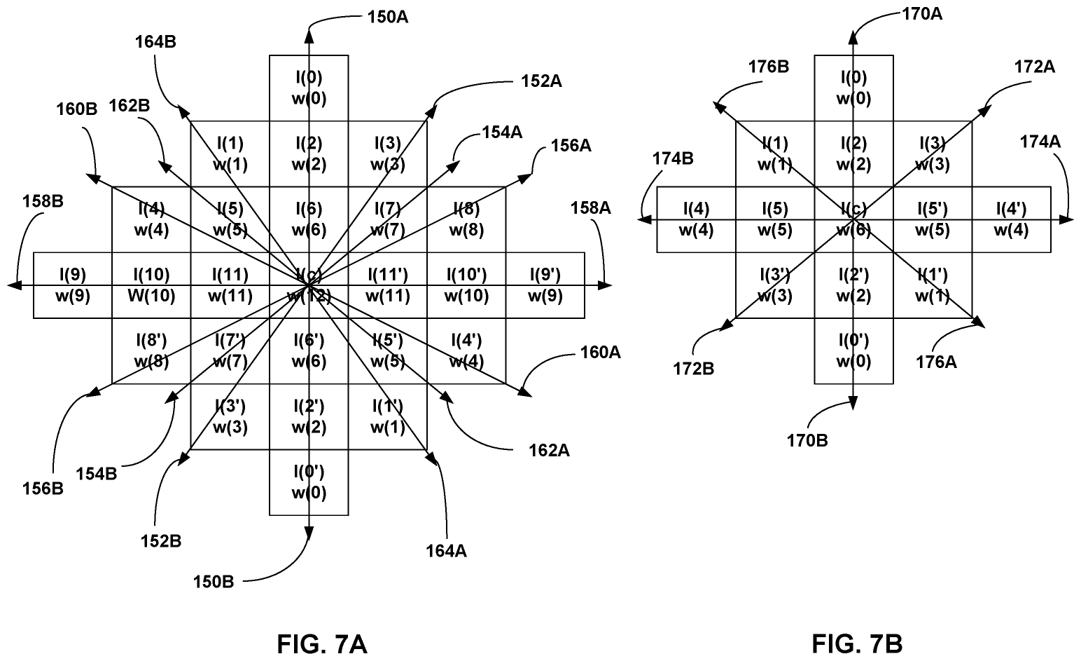

FIGS. 7A and 7B are conceptual diagrams illustrating example locations of input samples for performing ALF in accordance with techniques described in this disclosure. FIGS. 7A and 7B assist in understanding the examples of the ALF process described in this disclosure. For example, FIG. 7A illustrates the mapping of input samples to respective filter coefficients for 7×7 ALF and FIG. 7B illustrates the mapping of input samples to respective filter coefficients for 5×5 ALF. To reiterate, video encoder 200 and video decoder 300 may be configured to perform ALF by performing the following: O′=I(c)+Σ_{i=0 . . . 5 or 0 . . . 11}w(i)*[K(I(i)+I(i′)−2*I(c),k(i))] (equation 9), where O′ is the filtered sample and I(c) is the current sample for which the ALF process is being performed.

In FIG. 7A, the current sample (I(c)) is in the center. Video encoder 200 and video decoder 300 may determine a first set of input samples including input samples located along a first one or more directions relative to the current sample. For instance, in FIG. 7A, the first one or more directions include vertical direction 150A, diagonal direction 152A, diagonal direction 154A, diagonal direction 156A, horizontal direction 158B, diagonal direction 164B, diagonal direction 162B, and diagonal direction 160B.

Video encoder 200 and video decoder 300 may determine a second set of input samples including input samples located along a second one or more directions relative to the current sample. The second one or more directions are symmetrically opposite to the first one or more directions relative to the current sample. For example, in FIG. 7A, the second one or more directions include vertical direction 150B, diagonal direction 152B, diagonal direction 154B, diagonal direction 156B, horizontal direction 158A, diagonal direction 160A, diagonal direction 162A, and diagonal direction 164A.

Vertical direction 150A and vertical direction 150B are symmetrically opposite directions relative to the current sample. For example, a line extending in vertical direction 150A starting from the current sample (I(c)) and a line extending in vertical direction 150B starting from the current sample (I(c)) would be 180-degrees relative to one another. Similarly, diagonal direction 152A and diagonal direction 152B are symmetrically opposite directions relative to the current sample. For example, a line extending in diagonal direction 152A starting from the current sample (I(c)) and a line extending in diagonal direction 152B starting from the current sample (I(c)) would be 180-degrees relative to one another, and so forth for the example directions illustrated in FIG. 7A.

As illustrated, vertical direction 150A includes samples I(6), I(2), and I(0), and vertical direction 150B includes samples I(6′), I(2′), and I(0′). I(6) and I(6′) represent symmetrical samples because both I(6) and I(6′) are equidistant to the current sample I(c) and are in symmetrically opposite directions. Similarly, I(2) and I(2′) represent symmetrical samples because both I(2) and I(2′) are equidistant to the current sample I(c) and are in symmetrically opposite directions.

The same holds true for the samples along the diagonal directions and the horizontal directions. For example, diagonal direction 156A includes sample I(8), and diagonal direction 156B, which is symmetrically opposite to diagonal direction 156A, includes sample I(8′). I(8) and I(8′) represent symmetrical samples because both I(8) and I(8′) are equidistant to the current sample I(c) and are in symmetrically opposite directions. Horizontal direction 158B includes samples I(11), I(10), and I(9), and horizontal direction 158A includes samples I(11′), I(10′), and I(9′). I(11), I(10), and I(9) and I(11′), I(10′), and I(9′), respectively, represent symmetrical samples because I(11), I(10), and I(9) and I(11′), I(10′), and I(9′), respectively, are equidistant to the current sample I(c) and are in symmetrically opposite directions.

Accordingly, video encoder 200 and video decoder 300 may determine a first set of input samples comprising input samples located along a first one or more directions relative to the current sample. Examples of the first one or more directions include a first vertical direction (e.g., vertical direction 150A), a first horizontal direction (e.g., horizontal direction 158B), and one or more first diagonal directions (e.g., diagonal directions 152A, 154A, 156A, 164B, 162B, and 160B). Video encoder 200 and video decoder 300 may determine a second set of input samples comprising input samples located along a second one or more directions relative to the current sample. Examples of the second one or more directions include a second vertical direction (e.g., vertical direction 150B), a second horizontal direction (e.g., horizontal direction 158A), and one or more second diagonal directions (e.g., diagonal directions 152B, 154B, 156B, 164A, 162A, and 160A). As described above, the second one or more directions are symmetrically opposite to the first one or more directions relative to the current sample.

In FIG. 7B, the current sample (I(c)) is in the center, same as in FIG. 7A. Video encoder 200 and video decoder 300 may determine a first set of input samples including input samples located along a first one or more directions relative to the current sample. For instance, in FIG. 7B, the first one or more directions include vertical direction 170A, diagonal direction 172A, horizontal direction 174B, and diagonal direction 176B.

Video encoder 200 and video decoder 300 may determine a second set of input samples include input samples located along a second one or more directions relative to the current sample. The second one or more directions are symmetrically opposite to the first one or more directions relative to the current sample. For example, in FIG. 7B, the second one or more directions include vertical direction 170B, diagonal direction 172B, horizontal direction 174A, and diagonal direction 176A.

Vertical direction 170A and vertical direction 170B are symmetrically opposite directions relative to the current sample. For example, a line extending in vertical direction 170A starting from the current sample (I(c)) and a line extending in vertical direction 170B starting from the current sample (I(c)) would be 180-degrees relative to one another. Similarly, diagonal direction 172A and diagonal direction 172B are symmetrically opposite directions relative to the current sample. For example, a line extending in diagonal direction 172A starting from the current sample (I(c)) and a line extending in diagonal direction 172B starting from the current sample (I(c)) would be 180-degrees relative to one another, and so forth for the example directions illustrated in FIG. 7B.

As illustrated, vertical direction 170A includes samples I(2) and I(0), and vertical direction 170B includes samples I(2′) and I(0′). I(2) and I(0) and I(2′) and I(0′), respectively, represent symmetrical samples because I(2) and I(0) and I(2′) and I(0′), respectively, are equidistant to the current sample I(c) and are in symmetrically opposite directions.

The same holds true for the samples along the diagonal directions and the horizontal directions. For example, diagonal direction 172A includes sample I(3), and diagonal direction 172B, which is symmetrically opposite to diagonal direction 172A, includes sample I(3′). I(3) and I(3′) represent symmetrical samples because both I(3) and I(3′) are equidistant to the current sample I(c) and are in symmetrically opposite directions. Horizontal direction 174B includes samples I(5) and I(4), and horizontal direction 174A includes samples I(5′) and I(4′). I(5) and I(4) and I(5′) and I(4′), respectively, represent symmetrical samples because I(5) and I(4) and I(5′) and I(4′), respectively, are equidistant to the current sample I(c) and are in symmetrically opposite directions.

Accordingly, video encoder 200 and video decoder 300 may determine a first set of input samples comprising input samples located along a first one or more directions relative to the current sample. Examples of the first one or more directions include a first vertical direction (e.g., vertical direction 170A), a first horizontal direction (e.g., horizontal direction 174B), and one or more first diagonal directions (e.g., diagonal direction 172A). Video encoder 200 and video decoder 300 may determine a second set of input samples comprising input samples located along a second one or more directions relative to the current sample. Examples of the second one or more directions include a second vertical direction (e.g., vertical direction 170B), a second horizontal direction (e.g., horizontal direction 174A), and one or more second diagonal directions (e.g., diagonal direction 172B). As described above, the second one or more directions are symmetrically opposite to the first one or more directions relative to the current sample.

Video encoder 200 and video decoder 300 may determine the first set of input samples and the second set of input samples for performing a clipping function. For instance, one example of the clipping function is K(d, b), where K(d, b) equals the minimum between b and the maximum between negative b and d (i.e., K(d, b)=min(b, max(−b,d)).

In one or more examples, for the ALF process, d equals (I(i)+I(i′)−2*I(c)) and b equals k(i), where k(i) is the clipping parameter determined by video encoder 200 and signaled to video decoder 300. Accordingly, the clipping function can be written as K(I(i)+I(i′)−2*I(c), k(i)). For the clipping function, I(i) represents an input sample from the first set of input samples and I(i′) represents an input sample from the second set of input samples that is symmetrically opposite to the input sample from the first set of input samples. Accordingly, video encoder 200 and video decoder 300 may perform a clipping function based at least in part on the first set of input samples (e.g., I(i)) and the second set of input samples (e.g., I(i′)) to generate respective clipped samples. In some examples, video encoder 200 and video decoder 300 may perform a clipping function based at least in part on the first set of input samples (e.g., I(i)) and the second set of input samples (e.g., I(i′)) and respective clipping parameters (k(i)) to generate respective clipped samples. That is, for each “i” and “i′” pair there is a corresponding clipped sample generated based on the clipping function K(I(i)+I(i′)−2*I(c), k(i)), where I(i) and I(i′) are from the first and second set of input samples from symmetrically opposite directions and k(i) is the respective clipping parameter.

As described above, for K(d, b)=min(b, max(−b,d)), k(i) is equal to b and (I(i)+I(i′)−2*I(c)) is equal to d. To perform the clipping function, video encoder 200 or video decoder 300 may multiply respective clipping parameters by −1 to determine negative clipping parameters (e.g., to determine −b). Video encoder 200 and video decoder 300 may determine respective maximum values between respective negative clipping parameters and respective values determined from the first set of input samples, the second set of input samples, and the current sample. The respective values determined from the first set of input samples, the second set of input samples, and the current sample may be (I(i)+I(i′)−2*I(c)), which is equal to d, as described above. Accordingly, video encoder 200 and video decoder 300 may determine max(−b,d), which are respective maximum values.

Video encoder 200 and video decoder 300 may determine respective minimum values between respective clipping parameters and respective maximum values to generate the respective clipped samples. In other words, video encoder 200 and video decoder 300 may determine min(b, max(−b,d)), and the result may be respective clipped samples (e.g., the result from the clipping function).

Video encoder 200 and video decoder 300 may perform ALF on the current sample based at least in part on the respective clipped samples to generate a filtered sample. For example, video encoder 200 and video decoder 300 may multiply respective filter coefficients (e.g., w(i)) with the respective generated clipped samples to generate respective intermediate values. As one example, video encoder 200 and video decoder 300 may determine w(i)*[K(I(i)+I(i′)−2*I(c), k(i))], where K(I(i)+I(i′)−2*I(c), k(i)) represents respective clipped samples, w(i) represents respective filter coefficients, and the result of w(i)*[K(I(i)+I(i′)−2*I(c), k(i)) is respective intermediate values.

Video encoder 200 and video decoder 300 may sum the respective intermediate values to generate an offset value. For example, video encoder 200 and video decoder 300 may perform Σ_{i=0 . . . 5 or 0 . . . 11}w(i)*[I((I(i)+I(i′)−2*I(c),k(i))] to generate an offset value, where i goes from 0 to 5 for a 5×5 ALF filter and goes from 0 to 11 for a 7×7 ALF filter. Video encoder 200 and video decoder 300 may add the current sample I(c) to the offset value to generate the filtered sample (i.e., O′=I(c)+Σ_{i=0 . . . 5 or 0 . . . 11}w(i)*[K(I(i)+I(i′)−2*I(c),k(i))], where O′ is the filtered sample and I(c) is added to the offset value represented by Σ_{i=0 . . . 5 or 0 . . . 11}w(i)*[K(I(i)+I(i′)−2*I(c),k(i))].

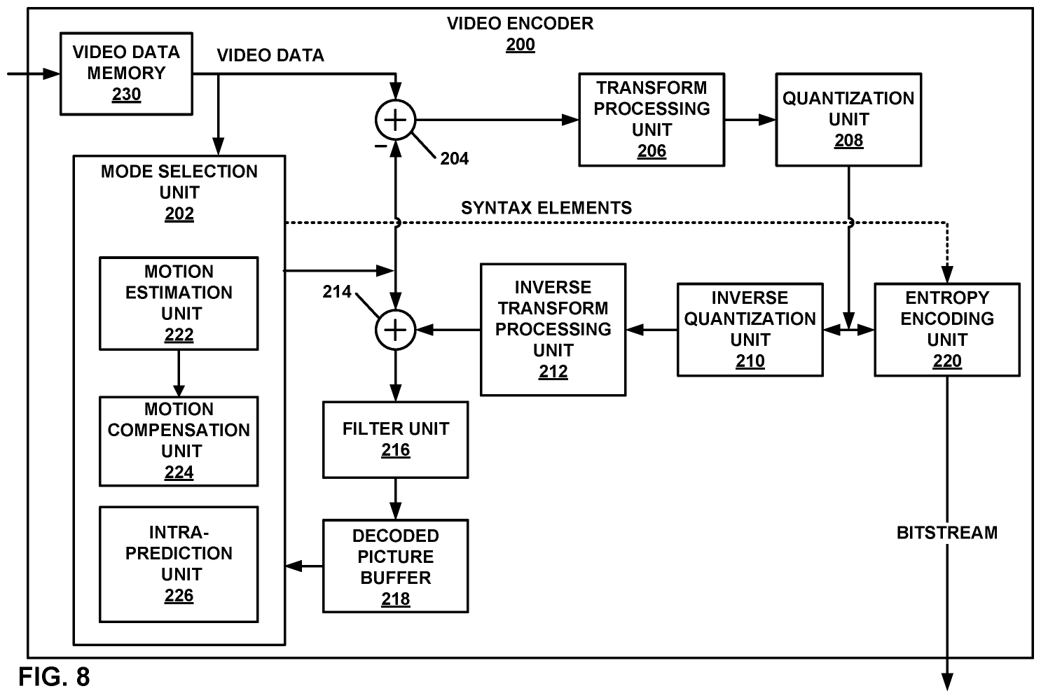

FIG. 8 is a block diagram illustrating an example video encoder 200 that may perform the techniques of this disclosure. FIG. 8 is provided for purposes of explanation and should not be considered limiting of the techniques as broadly exemplified and described in this disclosure. For purposes of explanation, this disclosure describes video encoder 200 in the context of video coding standards such as the HEVC (H.265) video coding standard and the VVC (e.g., H.266) video coding standard in development. However, the techniques of this disclosure are not limited to these video coding standards, and are applicable generally to video encoding and decoding.

In the example of FIG. 8, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 8 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Video encoder 200 may also include a reconstruction loop (also called decoding loop). Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples. Also, operations of filter unit 216 may be on the output of DPB 218 instead of input to DPB 218. As described below, filter unit 216 is configured to perform ALF techniques.

Video encoder 200 represents an example of a device configured to encode video data including a memory configured to store video data, and one or more processing units implemented in circuitry and configured to perform ALF filtering based on equation 9: O′=I(c)+Σ_{i=0 . . . 5 or 0 . . . 11}w(i)*[K(I(i)+I(i′)−2*I(c),k(i))]. For example, filter unit 216 may be configured to perform the operations of equation 9.

As one example, filter unit 216 may determine that adaptive loop filtering (ALF) is applied to a current sample of a block (e.g., based on information from mode selection unit 202). Filter unit 216 may determine a first set of input samples comprising input samples located along a first one or more directions relative to the current sample. Examples of the first one or more directions include vertical direction 150A, horizontal direction 158B, and one or more diagonal directions 152A, 154A, 156A, 164B, 162B, and 160B of FIG. 7A or vertical direction 170A, horizontal direction 174B, and one or more diagonal directions 172A of FIG. 7B.

Filter unit 216 may determine a second set of input samples comprising input samples located along a second one or more directions relative to the current sample. Examples of the second one or more directions includes vertical direction 150B, horizontal direction 158A, and one or more diagonal directions 152B, 154B, 156B, 164A, 162A, and 160A of FIG. 7A or vertical direction 170B, horizontal direction 174A, and one or more diagonal directions 172B of FIG. 7B. The second one or more directions may be symmetrically opposite to the first one or more directions relative to the current sample.

Filter unit 216 may perform a clipping function based at least in part on the first set of input samples and the second set of input samples, and in some examples, based on clipping parameters to generate respective clipped samples. For instance, filter unit 216 may perform K(I(i)+I(i′)−2*I(c), k(i)), where K(d, b) equals min(b, max(−b,d)). As one example, filter unit 216 may multiply or divide respective clipping parameters (e.g., k(i)) by −1 to determine negative clipping parameters and determine respective maximum values between respective negative clipping parameters and respective values determined from the first set of input samples, the second set of input samples, and the current sample. The respective values determined from the first set of input samples, the second set of input samples, and the current sample are equal to (I(i)+I(i′)−2*I(c)). In this way, filter unit 216 may determine max(−b, d). Filter unit 216 may determine respective minimum values between respective clipping parameters and respective maximum values to generate the respective clipped samples (e.g., determine min(b, max(−b,d)).

Filter unit 216 may perform ALF on the current sample based at least in part on the respective clipped samples to generate a filtered sample. For example, filter unit 216 may multiply respective filter coefficients with the respective generated clipped samples to generate respective intermediate values (e.g., where the respective intermediate values are w(i)*[K(I(i)+I(i′)−2*I(c), k(i))]). Filter unit 216 may sum the respective intermediate values to generate an offset value (e.g., where the offset value is equal to Σ_{i=0 . . . 5 or 0 . . . 11}w(i)*[K(I(i)+O(i′)−2*I(c),k(i))]). Filter unit 216 may add the current sample to the offset value to generate the filtered sample (e.g., where the filtered sample is equal to O′=I(c)+Σ_{i=0 . . . 5 or 0 . . . 11}w(i)*[K(I(i)+I(i′)−2*I(c),k(i))].

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

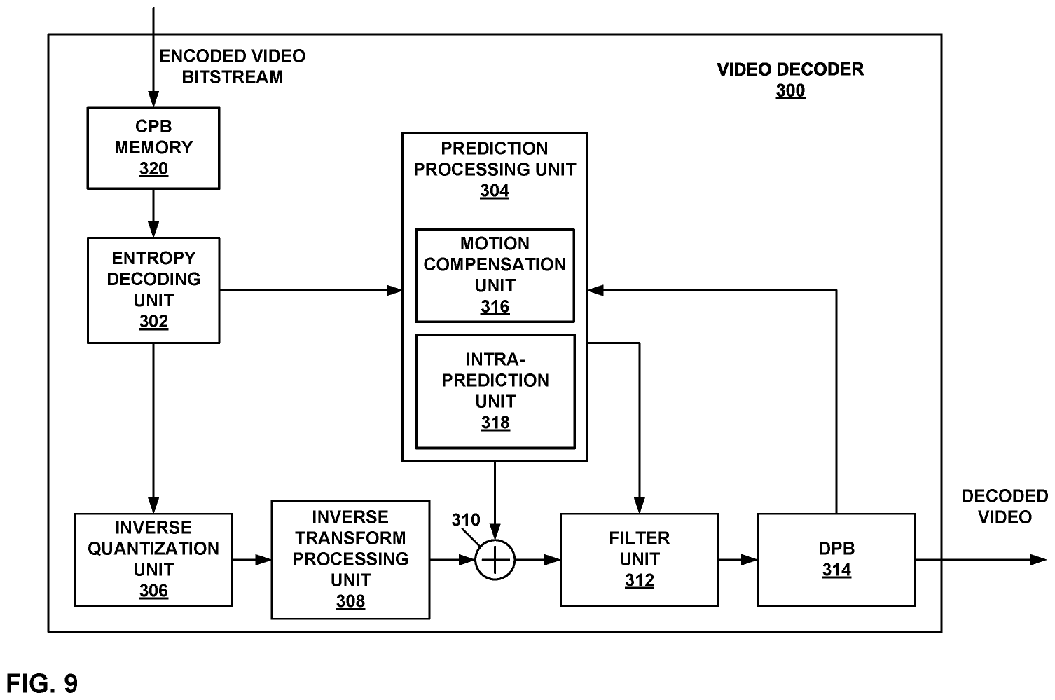

FIG. 9 is a block diagram illustrating an example video decoder 300 that may perform the techniques of this disclosure. FIG. 9 is provided for purposes of explanation and is not limiting on the techniques as broadly exemplified and described in this disclosure. For purposes of explanation, this disclosure describes video decoder 300 is described according to the techniques of JEM, VVC, and HEVC. However, the techniques of this disclosure may be performed by video coding devices that are configured to other video coding standards.

In the example of FIG. 9, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors, e.g., formed by processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output as pictures of the encoded video bitstream and/or use as reference video data when decoding subsequent data. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 9 are illustrated to assist with understanding the operations performed by video decoder 300. The units may be implemented as fixed-function circuits, programmable circuits, or a combination thereof. Similar to FIG. 8, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 8).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 8). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples. In some examples, filter unit 312 may perform the operations on the output of DPB 314 that is fed back to prediction processing unit 304. As described below, filter unit 312 may be configured to perform ALF techniques described in this disclosure.

Video decoder 300 represents an example of a device configured to decode video data including a memory configured to store video data, and one or more processing units implemented in circuitry and configured to perform ALF filtering based on the equation 9: O′=I(c)+Σ_{i=0 . . . 5 or 0 . . . 11}w(i)*[K(I(i)+I(i′)−2*I(c),k(i))]. For example, filter unit 312 may be configured to perform the operations of equation 9.

As one example, filter unit 312 may determine that adaptive loop filtering (ALF) is applied to be a current sample of a block (e.g., based on signaled information from video encoder 200). Filter unit 312 may determine a first set of input samples comprising input samples located along a first one or more directions relative to the current sample. Examples of the first one or more directions include vertical direction 150A, horizontal direction 158B, and one or more diagonal directions 152A, 154A, 156A, 164B, 162B, and 160B of FIG. 7A or vertical direction 170A, horizontal direction 174B, and one or more diagonal directions 172A of FIG. 7B.

Filter unit 312 may determine a second set of input samples comprising input samples located along a second one or more directions relative to the current sample. Examples of the second one or more directions includes vertical direction 150B, horizontal direction 158A, and one or more diagonal directions 152B, 154B, 156B, 164A, 162A, and 160A of FIG. 7A or vertical direction 170B, horizontal direction 174A, and one or more diagonal directions 172B of FIG. 7B. The second one or more directions may be symmetrically opposite to the first one or more directions relative to the current sample.

Filter unit 312 may perform a clipping function based at least in part on the first set of input samples and the second set of input samples, and in some examples, based on clipping parameters to generate respective clipped samples. For instance, filter unit 312 may perform K(I(i)+I(i′)−2*I(c), k(i)), where K(d, b) equals min(b, max(−b,d)). As one example, filter unit 312 may multiply or divide respective clipping parameters (e.g., k(i)) by −1 to determine negative clipping parameters and determine respective maximum values between respective negative clipping parameters and respective values determined from the first set of input samples, the second set of input samples, and the current sample. The respective values determined from the first set of input samples, the second set of input samples, and the current sample are equal to (I(i)+I(i′)−2*I(c)). In this way, filter unit 312 may determine max(−b, d). Filter unit 312 may determine respective minimum values between respective clipping parameters and respective maximum values to generate the respective clipped samples (e.g., determine min(b, max(−b,d)).

Filter unit 312 may perform ALF on the current sample based at least in part on the respective clipped samples to generate a filtered sample. For example, filter unit 312 may multiply respective filter coefficients with the respective generated clipped samples to generate respective intermediate values (e.g., where the respective intermediate values are w(i)*[K(I(i)+I(i′)−2*I(c), k(i))]). Filter unit 312 may sum the respective intermediate values to generate an offset value (e.g., where the offset value is equal to Σ_{i=0 . . . 5 or 0 . . . 11}w(i)*[K(I(i)+I(i′)−2*I(c), k(i))]). Filter unit 312 may add the current sample to the offset value to generate the filtered sample (e.g., where the filtered sample is equal to O′=I(c)+Σ_{i=0 . . . 5 or 0 . . . 11}w(i)*[K(I(i)+I(i′)−2*I(c),k(i))].

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

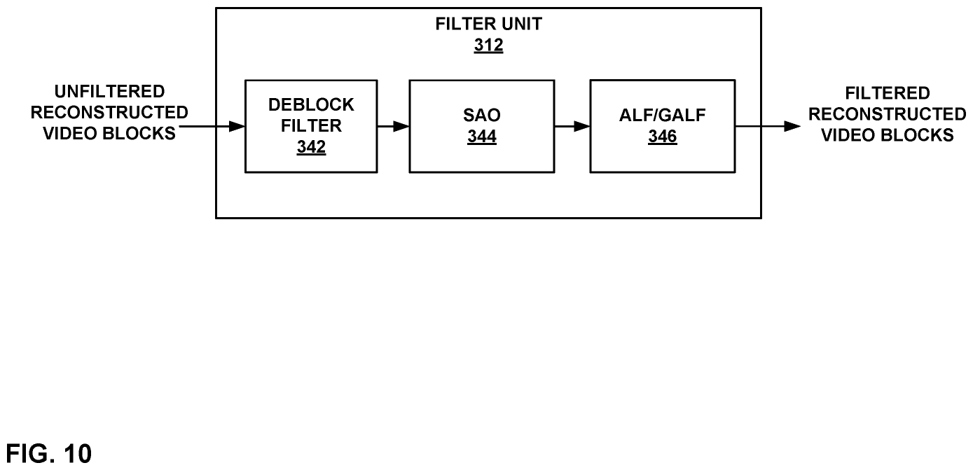

FIG. 10 shows an example implementation of filter unit 312. Filter unit 216 may be implemented in the same manner as filter unit 312. Filter units 216 and 312 may perform the techniques of this disclosure, possibly in conjunction with other components of video encoder 200 or video decoder 300. In the example of FIG. 10, filter unit 312 includes deblock filter 342, SAO filter 344, and ALF/GLAF filter 346. ALF/GLAF filter 346 may, for example, be configured to perform one or more example techniques described in this disclosure.

Filter unit 312 may include fewer filters and/or may include additional filters. Additionally, the particular filters shown in FIG. 10 may be implemented in a different order. Other loop filters (either in the coding loop or after the coding loop) may also be used to smooth pixel transitions or otherwise improve the video quality. The decoded video blocks in a given frame or picture are then stored in DPB 314, which stores reference pictures used for subsequent motion compensation. DPB 314 may be part of or separate from additional memory that stores decoded video for later presentation on a display device, such as display device 118 of FIG. 1.

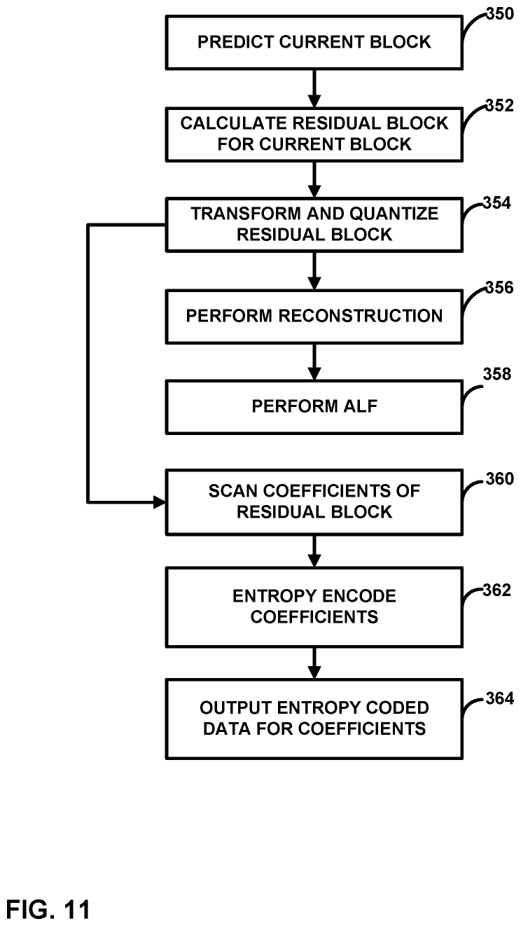

FIG. 11 is a flowchart illustrating an example method for encoding a current block. The current block may comprise a current CU. Although described with respect to video encoder 200 (FIGS. 1 and 8), it should be understood that other devices may be configured to perform a method similar to that of FIG. 11.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform and quantize coefficients of the residual block (354).

In some examples, video encoder 200 may be configured to perform a reconstruction loop (e.g., inverse quantization unit 210 and inverse transform processing unit 212) (356). Reconstruction unit 214 may sum the output of inverse transform processing unit 212 and predictive block. Filter unit 216 may then perform filtering (e.g., ALF filtering in accordance with examples described in this disclosure) based on the output from reconstruction unit 214 (358). However, as described above, filter unit 216 may perform filtering on the output of decoded picture buffer 218.

Video encoder 200 may scan the quantized transform coefficients of the residual block (360). During the scan, or following the scan, video encoder 200 may entropy encode the coefficients (362). For example, video encoder 200 may encode the coefficients using CAVLC or CABAC. Video encoder 200 may then output the entropy coded data of the block (364). The example operations described with respect to reference numerals 360, 362, and 364 may occur in parallel or sequentially, or in any order, with respect to the operations described with respect to reference numerals 356 and 358.

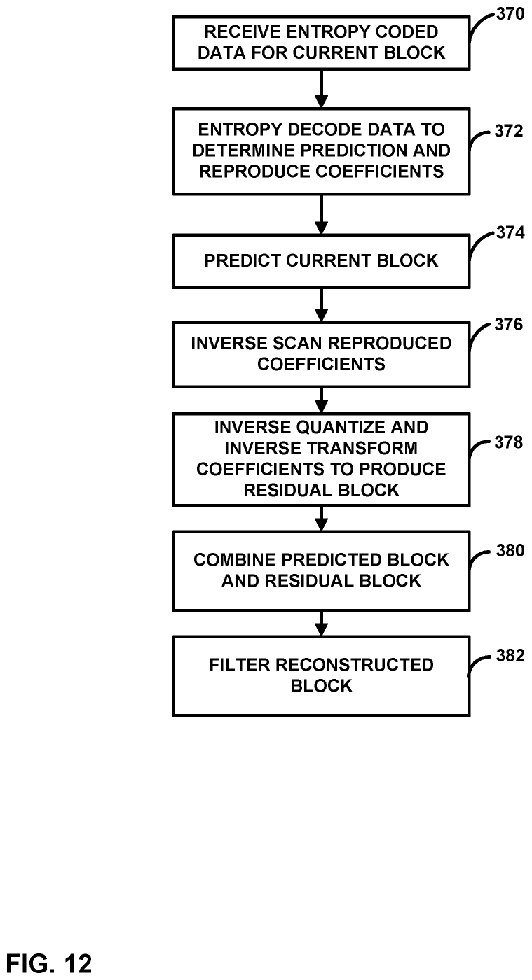

FIG. 12 is a flowchart illustrating an example method for decoding a current block of video data. The current block may comprise a current CU. Although described with respect to video decoder 300 (FIGS. 1 and 9), it should be understood that other devices may be configured to perform a method similar to that of FIG. 12.

Video decoder 300 may receive entropy coded data for the current block, such as entropy coded prediction information (e.g., syntax elements) and entropy coded data for coefficients of a residual block corresponding to the current block (370). Video decoder 300 may entropy decode the entropy coded data to determine prediction information for the current block and to reproduce coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced coefficients (376), to create a block of quantized transform coefficients. Video decoder 300 may then inverse quantize and inverse transform the coefficients to produce a residual block (378). Video decoder 300 may decode the current block by combining the prediction block and the residual block to determine a reconstructed block (380). Video decoder 300 may then filter the reconstructed block by applying one or more filters, such as an ALF (382).

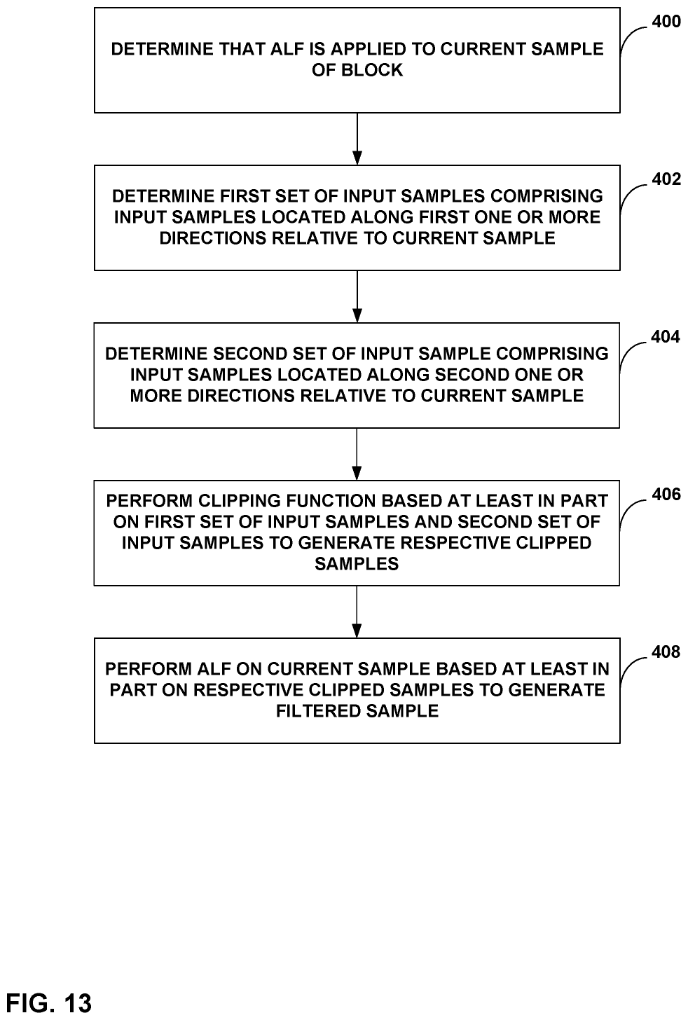

FIG. 13 is a flowchart illustrating an example of processing video data in accordance with one or more examples described in this disclosure. The example of FIG. 13 is described with respect to one or more processors comprising at least one of fixed-function or programmable circuitry. The one or more processors may be coupled to or may include memory configured to store input samples that are used for ALF. For instance, examples of the one or more processors include video encoder 200, and filter unit 216 of video encoder 200, or video decoder 300, and filter unit 312 of video decoder 300. As one example, where the one or more processors represent video encoder 200 or filter unit 216, the example of FIG. 13 may be performed subsequent to a reconstruction process in video encoder 200. As another example, where the one or more processors represent video decoder 300 or filter unit 312, the example of FIG. 13 may be performed subsequent to a decoding process of a block.

The one or more processors may determine that adaptive loop filtering (ALF) is applied to a current sample of a block (400). For example, mode selection unit 202 of video encoder 200 may determine that ALF is to be applied to a current sample of a block. In some examples, video encoder 200 may signal information indicating to video decoder 300 that ALF is applied to the current sample. However, there may be examples where video decoder 300 infers (e.g., without information from video encoder 200) that ALF is applied to the current sample (e.g., such as based on whether ALF was applied to a neighboring sample, a size of the block that includes the current sample, a block boundary of the block, and the like).

The one or more processors may determine a first set of input samples from the stored input samples comprising samples located along a first one or more directions relative to the current sample (402). The first one or more directions comprise one or more of a first horizontal direction, a first vertical direction, and one or more first diagonal directions. Examples of the first one or more directions include vertical direction 150A having input samples I(6), I(2), and I(0), horizontal direction 158B having input samples I(11), I(10), and I(9), and one or more diagonal directions 152A having input sample I(3), 154A having input sample I(7), 156A having input sample I(8), 164B having input sample 41), 162B having input sample I(5), and 160B having input sample I(4) of FIG. 7A and vertical direction 170A having input samples I(2) and I(0), horizontal direction 174B having input samples I(5) and I(4), and diagonal direction 172A having input sample I(3) of FIG. 7B.

The one or more processors may determine a second set of input samples from the stored input samples comprising samples located along a second one or more directions relative to the current sample (404). The second one or more directions are symmetrically opposite to the first one or more directions relative to the current sample. The second one or more directions comprise one or more of a second horizontal direction symmetrically opposite to the first horizontal direction, a second vertical direction symmetrically opposite to the first vertical direction, and one or more second diagonal directions symmetrically opposite to the one or more first diagonal directions. Examples of the second one or more directions include vertical direction 150B having input samples I(6′), I(2′), and I(0′), horizontal direction 158A having input samples I(11′), I(10′), and I(9′), and one or more diagonal directions 152B having input sample I(3′), 154B having input sample I(7′), 156B having input sample I(8′), 164A having input sample I(1′), 162A having input sample I(5′), and 160A having input sample I(4′) of FIG. 7A and vertical direction 170B having input samples I(2′) and I(0′), horizontal direction 174A having input samples I(5′) and I(4′), and diagonal direction 172B having input sample I(3′) of FIG. 7B.

The one or more processors may perform a clipping function to generate respective clipped samples based at least in part on the first set of input samples and the second set of input samples (406). In some examples, the one or more processors may perform the clipping function based at least in part on the first set of input samples, the second set of input samples, and respective clipping parameters (e.g., determined by video encoder 200 based on rate-distortion cost and signaled to video decoder 300).

To perform the clipping function, the one or more processors may multiply or divide respective clipping parameters by −1 to determine negative clipping parameters, determine respective maximum values between respective negative clipping parameters and respective values determined from the first set of input samples, the second set of input samples, and the current sample, and determine respective minimum values between respective clipping parameters and respective maximum values to generate the respective clipped samples. For example, to perform the clipping function, the one or more processors are configured to determine minimum(b, maximum (−b, d)) to generate respective clipped samples, where b equals k(i), where k(i) represents respective clipping parameters, where d equals (I(i)+I(i′)−2*I(c)), and where I(i) represents a first input sample from the first set of input samples, I(i′) represents a second input sample from the second set of input samples that is symmetrically opposite to the first input sample relative to the current sample, and I(c) represents the current sample.

The one or more processors may be configured to perform ALF on the current sample based at least in part on the respective clipped samples to generate a filtered sample (408). For example, the one or more processors may be configured to multiply respective filter coefficients with the respective generated clipped samples to generate respective intermediate values, sum the respective intermediate values to generate an offset value, and add the current sample to the offset value to generate the filtered sample. In this way, the one or more processors may perform the following operations to generate the filtered sample according to the following equation: O′=I(c)+Σ_{i=0 . . . 5 or 0 . . . 11}w(i)*[K(I(i)+I(i′)−2*I(c),k(i))].

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
determining that adaptive loop filtering (ALF) is applied to a current sample of a block;
determining a first set of input samples comprising input samples located along a first one or more directions relative to the current sample;
determining a second set of input samples comprising input samples located along a second one or more directions relative to the current sample, wherein the second one or more directions are symmetrically opposite to the first one or more directions relative to the current sample;
performing a clipping function based at least in part on the first set of input samples and the second set of input samples to generate respective clipped samples; and
performing ALF on the current sample based at least in part on the respective clipped samples to generate a filtered sample.

2. The method of claim 1, wherein the first one or more directions comprise one or more of a first horizontal direction, a first vertical direction, and one or more first diagonal directions, and wherein the second one or more directions comprise one or more of a second horizontal direction symmetrically opposite to the first horizontal direction, a second vertical direction symmetrically opposite to the first vertical direction, and one or more second diagonal directions symmetrically opposite to the one or more first diagonal directions.

3. The method of claim 1, wherein performing the clipping function comprises performing the clipping function based at least in part on the first set of input samples, the second set of input samples, and respective clipping parameters.

4. The method of claim 3, wherein performing the clipping function comprises:
multiplying or dividing respective clipping parameters by −1 to determine negative clipping parameters;
determining respective maximum values between respective negative clipping parameters and respective values determined from the first set of input samples, the second set of input samples, and the current sample; and
determining respective minimum values between respective clipping parameters and respective maximum values to generate the respective clipped samples.

5. The method of claim 1, wherein performing the clipping function comprises:
determining minimum(b, maximum (−b, d)) to generate respective clipped samples, wherein b equals k(i), wherein k(i) represents respective clipping parameters, wherein d equals (I(i)+I(i′)−2*I(c)), and wherein I(i) represents a first input sample from the first set of input samples, I(i′) represents a second input sample from the second set of input samples that is symmetrically opposite to the first input sample relative to the current sample, and I(c) represents the current sample.

6. The method of claim 5, wherein performing ALF on the current sample comprises:
multiplying respective filter coefficients with the respective generated clipped samples to generate respective intermediate values;
summing the respective intermediate values to generate an offset value; and
adding the current sample to the offset value to generate the filtered sample.

7. The method of claim 1, wherein performing ALF on the current sample comprises performing ALF on the current sample subsequent to a decoding process on the block in a video decoder.

8. The method of claim 1, wherein performing ALF on the current sample comprises performing ALF subsequent to a reconstruction process in a video encoder.

9. A device for processing video data, the device comprising:
a memory configured to store input samples; and
one or more processors comprising at least one of fixed-function or programmable circuitry, wherein the one or more processors are configured to:
determine that adaptive loop filtering (ALF) is applied to a current sample of a block;
determine a first set of input samples from the stored input samples comprising input samples located along a first one or more directions relative to the current sample;
determine a second set of input samples from the stored input samples comprising input samples located along a second one or more directions relative to the current sample, wherein the second one or more directions are symmetrically opposite to the first one or more directions relative to the current sample;
perform a clipping function based at least in part on the first set of input samples and the second set of input samples to generate respective clipped samples; and
perform ALF on the current sample based at least in part on the respective clipped samples to generate a filtered sample.

10. The device of claim 9, wherein the first one or more directions comprise one or more of a first horizontal direction, a first vertical direction, and one or more first diagonal directions, and wherein the second one or more directions comprise one or more of a second horizontal direction symmetrically opposite to the first horizontal direction, a second vertical direction symmetrically opposite to the first vertical direction, and one or more second diagonal directions symmetrically opposite to the one or more first diagonal directions.

11. The device of claim 9, wherein to perform the clipping function, the one or more processors are configured to perform the clipping function based at least in part on the first set of input samples, the second set of input samples, and respective clipping parameters.

12. The device of claim 11, wherein to perform the clipping function, the one or more processors are configured to:
multiply or divide respective clipping parameters by −1 to determine negative clipping parameters;
determine respective maximum values between respective negative clipping parameters and respective values determined from the first set of input samples, the second set of input samples, and the current sample; and
determine respective minimum values between respective clipping parameters and respective maximum values to generate the respective clipped samples.

13. The device of claim 9, wherein to perform the clipping function, the one or more processors are configured to:
determine minimum(b, maximum (−b, d)) to generate respective clipped samples, wherein b equals k(i), wherein k(i) represents respective clipping parameters, wherein d equals (I(i)+I(i′)−2*I(c)), and wherein I(i) represents a first input sample from the first set of input samples, I(i′) represents a second input sample from the second set of input samples that is symmetrically opposite to the first input sample relative to the current sample, and I(c) represents the current sample.

14. The device of claim 13, wherein to perform ALF on the current sample, the one or more processors are configured to:
multiply respective filter coefficients with the respective generated clipped samples to generate respective intermediate values;
sum the respective intermediate values to generate an offset value; and
add the current sample to the offset value to generate the filtered sample.

15. The device of claim 9, wherein the one or more processors form a video decoder, and wherein to perform ALF on the current sample, the video decoder is configured to perform ALF on the current sample subsequent to a decoding process on the block.

16. The device of claim 9, wherein the one or more processors form a video encoder, and wherein to perform ALF on the current sample, the video encoder is configured to perform ALF subsequent to a reconstruction process in the video encoder.

17. A device for processing video data, the device comprising:
means for determining that adaptive loop filtering (ALF) is applied to a current sample of a block;
means for determining a first set of input samples comprising input samples located along a first one or more directions relative to the current sample;
means for determining a second set of input samples comprising input samples located along a second one or more directions relative to the current sample, wherein the second one or more directions are symmetrically opposite to the first one or more directions relative to the current sample;
means for performing a clipping function based at least in part on the first set of input samples and the second set of input samples to generate respective clipped samples; and
means for performing ALF on the current sample based at least in part on the respective clipped samples to generate a filtered sample.

18. The device of claim 17, wherein the first one or more directions comprise one or more of a first horizontal direction, a first vertical direction, and one or more first diagonal directions, and wherein the second one or more directions comprise one or more of a second horizontal direction symmetrically opposite to the first horizontal direction, a second vertical direction symmetrically opposite to the first vertical direction, and one or more second diagonal directions symmetrically opposite to the one or more first diagonal directions.

19. The device of claim 17, wherein the means for performing the clipping function comprises means for performing the clipping function based at least in part on the first set of input samples, the second set of input samples, and respective clipping parameters.

20. The device of claim 19, wherein the means for performing the clipping function comprises:
means for multiplying or dividing respective clipping parameters by −1 to determine negative clipping parameters;
means for determining respective maximum values between respective negative clipping parameters and respective values determined from the first set of input samples, the second set of input samples, and the current sample; and
means for determining respective minimum values between respective clipping parameters and respective maximum values to generate the respective clipped samples.

21. The device of claim 17, wherein the means for performing the clipping function comprises:
means for determining minimum(b, maximum (−b, d)) to generate respective clipped samples, wherein b equals k(i), wherein k(i) represents respective clipping parameters, wherein d equals (I(i)+I(i′)−2*I(c)), and wherein I(i) represents a first input sample from the first set of input samples, I(i′) represents a second input sample from the second set of input samples that is symmetrically opposite to the first input sample relative to the current sample, and I(c) represents the current sample.

22. The device of claim 21, wherein the means for performing ALF on the current sample comprises:
means for multiplying respective filter coefficients with the respective generated clipped samples to generate respective intermediate values;
means for summing the respective intermediate values to generate an offset value; and
means for adding the current sample to the offset value to generate the filtered sample.

23. A computer-readable storage medium having instructions stored thereon that when executed cause one or more processors to:
determine that adaptive loop filtering (ALF) is applied to a current sample of a block;
determine a first set of input samples comprising input samples located along a first one or more directions relative to the current sample;
determine a second set of input samples comprising input samples located along a second one or more directions relative to the current sample, wherein the second one or more directions are symmetrically opposite to the first one or more directions relative to the current sample;
perform a clipping function based at least in part on the first set of input samples and the second set of input samples to generate respective clipped samples; and
perform ALF on the current sample based at least in part on the respective clipped samples to generate a filtered sample.

24. The computer-readable storage medium of claim 23, wherein the first one or more directions comprise one or more of a first horizontal direction, a first vertical direction, and one or more first diagonal directions, and wherein the second one or more directions comprise one or more of a second horizontal direction symmetrically opposite to the first horizontal direction, a second vertical direction symmetrically opposite to the first vertical direction, and one or more second diagonal directions symmetrically opposite to the one or more first diagonal directions.

25. The computer-readable storage medium of claim 23, wherein the instructions that cause the one or more processors to perform the clipping function comprise instructions that cause the one or more processors to perform the clipping function based at least in part on the first set of input samples, the second set of input samples and respective clipping parameters.

26. The computer-readable storage medium of claim 25, wherein the instructions that cause the one or more processors to perform the clipping function comprise instructions that cause the one or more processors to:
multiply or divide respective clipping parameters by −1 to determine negative clipping parameters;
determine respective maximum values between respective negative clipping parameters and respective values determined from the first set of input samples, the second set of input samples, and the current sample; and
determine respective minimum values between respective clipping parameters and respective maximum values to generate the respective clipped samples.

27. The computer-readable storage medium of claim 23, wherein the instructions that cause the one or more processors to perform the clipping function comprise instructions that cause the one or more processors to:
determine minimum(b, maximum (−b, d)) to generate respective clipped samples, wherein b equals k(i), wherein k(i) represents respective clipping parameters, wherein d equals (I(i)+I(i′)−2*I(c)), and wherein I(i) represents a first input sample from the first set of input samples, I(i′) represents a second input sample from the second set of input samples that is symmetrically opposite to the first input sample relative to the current sample, and I(c) represents the current sample.

28. The computer-readable storage medium of claim 27, wherein the instructions that cause the one or more processors to perform ALF on the current sample comprise instructions that cause the one or more processors to:
multiply respective filter coefficients with the respective generated clipped samples to generate respective intermediate values;
sum the respective intermediate values to generate an offset value; and
add the current sample to the offset value to generate the filtered sample.
